(19) United States
(12) Patent Application Publication
(10) Pub. No.: US 2024/0210512 A1
(43) Pub. Date: Jun. 27, 2024

(54) MANAGEMENT APPARATUS AND MANAGEMENT METHOD

(71) Applicant: HONDA MOTOR CO., LTD., Tokyo (JP)

(72) Inventors: Shohei Namiki, Tokyo (JP); Katsuya Takegoshi, Tokyo (JP); Satoshi Murata, Tokyo (JP); Yuko Furuichi, Raymond, OH (US); Sota Sakaguchi, Raymond, OH (US)

(21) Appl. No.: 18/088,893

(22) Filed: Dec. 27, 2022

(51) Int. Cl. G01S 5/00

(52) U.S. Cl. CPC G01S 5/0045

(57) ABSTRACT

A management apparatus according to one aspect of the present invention includes a control device configured to acquire a plurality of pieces of positional information of a device to be managed over a predetermined period, and determine an area in which each positional information corresponding to predetermined area are obtained the most in the predetermined period as an area in which the device to be managed has been present in the predetermined period.

### FIELD

Embodiments described herein relate generally to a management apparatus and a management method.

### BACKGROUND

Conventionally, technologies for managing the operation status (especially position) of a device have been proposed. In such technologies, for example, positional information is periodically transmitted from a device in operation, and it is possible to ascertain the position of the device in operation by collecting the transmitted positional information. However, the positional information cannot always be acquired accurately. For this reason, the collected positional information may not accurately reflect an actual situation in some cases. Therefore, there has been a possibility of the accuracy of the position of a device to be managed having deteriorated.

The present invention has been made in view of such circumstances, and an object thereof is to provide a management apparatus and a management method capable of curbing deterioration in accuracy of the position of a device to be managed.

### BRIEF DESCRIPTION OF THE DRAWINGS

FIG. 1 is a schematic block diagram which shows a system configuration of a management system 100 according to an embodiment.

FIG. 2 is a diagram which shows a specific example of a functional configuration of the management apparatus 40.

FIG. 3 is a diagram which shows a specific example of operation information.

FIG. 4 is a diagram which shows a specific example of basic operation information continuously obtained from the same device in the management apparatus 40.

FIG. 5 is a diagram which shows a specific example of basic operation information continuously obtained from the same device in the management apparatus 40.

FIG. 6 is a diagram which shows a specific example of basic operation information continuously obtained from the same device in the management apparatus 40.

FIG. 7 is a diagram which shows a specific example of basic operation information continuously obtained from the same device in the management apparatus 40.

FIG. 8 is a diagram which shows a specific example of basic operation information continuously obtained from the same device in the management apparatus 40.

FIG. 9 is a diagram which shows a specific example of basic operation information continuously obtained from the same device in the management apparatus 40.

FIG. 10 is a flowchart which shows a specific example of processing of an operation information management unit 432 provided in the management apparatus 40.

FIG. 11 is a flowchart which shows another specific example of the processing of the operation information management unit 432 provided in the management apparatus 40.

FIG. 12 is a diagram which shows an outline of a hardware configuration example of an information processing apparatus 70 applied to the present embodiment.

FIG. 13 is a diagram for describing an example of a travel trajectory of first equipment according to the embodiment.

### DETAILED DESCRIPTION

A management apparatus and a management method according to the present invention have adopted the following configuration.
(1): A management apparatus according to one aspect of the present invention includes a control device configured to acquire a plurality of pieces of positional information of a device to be managed over a predetermined period, and determine an area in which each positional information corresponding to predetermined area obtained the most in the predetermined period as an area in which the device to be managed has been present in the predetermined period.
(2): In the management apparatus according to the aspect of (1) of the present invention, the control device determines an area in which the device to be managed has been present on the basis of positional information obtained outside the predetermined period when a predetermined number or more of pieces of positional information are not obtained in the predetermined period.
(3): In the management apparatus according to the aspect of (2) of the present invention, the control device determines an area in which the device to be managed has been present on the basis of positional information obtained at a timing after an end of the predetermined period and closest to the end of the predetermined period.
(4): In the management apparatus according to the aspect of (2) of the present invention, the control device determines an area in which the device to be managed has been present on the basis of positional information obtained at a timing closest to the predetermined period.
(5): A management method according to another aspect of the present invention includes acquiring a plurality of pieces of positional information of a device to be managed over a predetermined period, and determining an area in which each positional information corresponding to predetermined area obtained the most in the predetermined period as an area in which the device to be managed has been present in the predetermined period.
(6): A management method according to another aspect of the present invention includes acquiring a plurality of pieces of positional information of a device to be managed over a predetermined period; and determining an area in which the device to be managed has been present on the basis of positional information obtained outside the predetermined period when each piece of the positional information corresponding to predetermined areas is not obtained in the predetermined period.
(7): In the management method according to the aspect of (6) of the present invention, wherein determining an area in which the device to be managed has been present on the basis of positional information obtained at a timing after an end of the predetermined period and closest to the end of the predetermined period.
(8): In the management method according to the aspect of (6) of the present invention, wherein determining an area in which the device to be managed has been present on the basis of positional information obtained at a timing closest to the predetermined period.

According to (1) and (5), a most common area among areas according to each piece of the positional information obtained in a predetermined period is determined as an area in which a device to be managed has been present in the predetermined period. For this reason, it is possible to curb a deterioration in accuracy of the position of a device to be managed.

According to (2), when a predetermined number or more of pieces of positional information are not obtained in a predetermined period, an area in which the device to be managed has been present is determined on the basis of positional information obtained outside the predetermined period. For this reason, even if a predetermined number or more of pieces of positional information are not obtained in a predetermined period, it is possible to determine a position of the device to be managed, and it is possible to curb a deterioration in accuracy of the position.

According to (3), an area in which a device to be managed has been present is determined on the basis of positional information obtained at a timing after an end of a predetermined period and closest to the end of the predetermined period. For this reason, even if a predetermined number or more of pieces of positional information are not obtained in a predetermined period, it is possible to determine a position of the device to be managed, and it is possible to curb a deterioration in accuracy of the position.

According to (4), an area in which a device to be managed has been present is determined on the basis of positional information obtained at a timing closest to a predetermined period. For this reason, even if a predetermined number or more of pieces of positional information are not obtained in the predetermined period, it is possible to determine a position of the device to be managed, and it is possible to curb a deterioration in accuracy of the position.

Hereinafter, embodiments of the management apparatus and the management method of the present invention will be described with reference to the drawings.

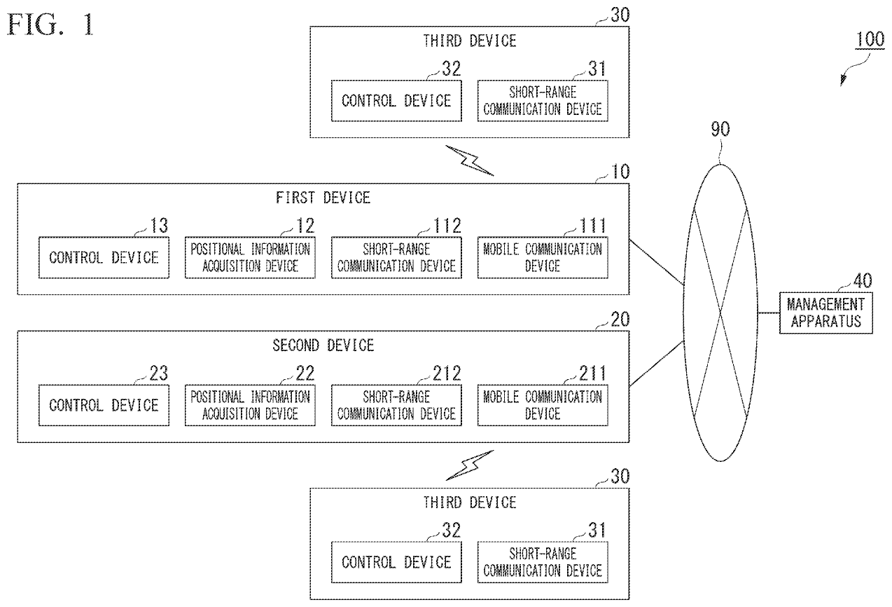

FIG. 1 is a schematic block diagram which shows a system configuration of a management system 100 according to one embodiment. First, an outline of the management system 100 will be described. The management system 100 includes a first device 10, a second device 20, a third device 30, and a management apparatus 40. The first device 10, the second device 20, and the third device 30 communicate with the management apparatus 40 via a network 90. The network 90 may be a network using wireless communication or a network using wired communication. The network 90 may be configured by combining a plurality of networks. Each device will be further described in detail below. In the following description, at least the second device 20 is a device to be managed.

The first device 10 is a device in which one thereof is assigned to one unit group. For each unit group, an operation status of a device (the second device 20 and the third device 30) used by members belonging to a corresponding group is managed. The first device 10 may be any device as long as it is used by the members of a unit group. For example, the first device 10 may be a mobile object on which at least one or more persons (members) can ride and move. More specifically, the first device 10 may be a four-wheeled vehicle such as a truck, a passenger car, or a van. The first device 10 may be any device as long as it can move with some or all of the members of a unit group.

The first device 10 includes a mobile communication device 111, a short-range communication device 112, a positional information acquisition device 12, and a control device 13. The mobile communication device 111 communicates with the management apparatus 40 via the network 90. The short-range communication device 112 wirelessly communicates with other short-range communication devices positioned within a range of a predetermined short distance from a host device. The short-range communication device 112 may perform communication using, for example, a wireless local area network (LAN) communication standard, may perform communication using a Bluetooth (registered trademark) communication standard, or may perform communication using other communication standards. The short-range communication device 112 wirelessly communicates, for example, with a short-range communication device 31 of the third device 30.

The positional information acquisition device 12 acquires positional information of a current position of the first device 10. The positional information acquisition device 12 acquires the positional information of the current position through, for example, communication with a satellite positioning system or a base station of a mobile phone network. Specific examples of the satellite positioning system include global positioning system (GPS), Galileo, and the like. The positional information acquisition device 12 outputs the acquired positional information to the control device 13.

The control device 13 includes a processor such as a central processing unit (CPU) and a memory. The control device 13 operates when the processor executes a program (for example, a program stored in a storage device such as a magnetic storage device or a semiconductor storage device). All or a part of functions of the control device 13 may be realized using hardware such as an application specific integrated circuit (ASIC), a programmable logic device (PLD), or a field programmable gate array (FPGA).

The control device 13 generates management information including identification information thereof stored in its own storage device and the positional information acquired by the positional information acquisition device 12 every time a predetermined timing arrives. The control device 13 transmits the generated management information to the management apparatus 40 via the mobile communication device 111.

The control device 13 receives identification information indicating the third device 30 and information on an operation status of the third device 30, which will be described below, from the third device 30 via the short-range communication device 112. The control device 13 generates basic operation information including the received information and positional information thereof. The control device 13 transmits the generated basic operation information to the management apparatus 40 via the mobile communication device 111.

The second device 20 is a device in which one or a plurality thereof are assigned to one unit group. The second device 20 is a device used by the members of a unit group, and is a device whose operation status in a predetermined area is managed. The second device 20 is, for example, a device used when predetermined work is performed. Such predetermined work may be any work. For example, the predetermined work may be lawn mowing work, may be a cleaning work, may be landscaping work, may be tree cutting work, may be manufacturing work, or may also be other work. When the predetermined work is lawn mowing work, specific examples of the second device 20 include a lawn mower operated by an engine and moved by a person walking, and a lawn mower operated by an engine and moved by a person riding thereon and driving it. The second device 20 may be a device operated by an electric motor instead of an engine, or may be a device operated by electrically operating a device other than the motor. The second device 20 may be configured as, for example, a device with a battery.

The second device 20 includes a mobile communication device 211, a short-range communication device 212, a positional information acquisition device 22, and a control device 23. The mobile communication device 211 communicates with the management apparatus 40 via the network 90. The short-range communication device 212 wirelessly communicates with other short-range communication devices positioned within a range of a predetermined short distance from a host device. The short-range communication device 212 may perform communication using, for example, a wireless LAN communication standard, may perform communication using a Bluetooth communication standard, or may perform communication using other communication standards. The short-range communication device 212 wirelessly communicates, for example, with the short-range communication device 31 of the third device 30.

The positional information acquisition device 22 acquires the positional information of a current position of the second device 20. The positional information acquisition device 22 acquires the positional information of the current position through, for example, communication with the satellite positioning system or the base station of a mobile phone network. Specific examples of the satellite positioning system include GPS, Galileo, and the like. The positional information acquisition device 22 outputs the acquired positional information to the control device 23.

The control device 23 includes a processor such as a CPU and a memory. The control device 23 operates when the processor executes a program (for example, a program stored in the storage device such as a magnetic storage device or a semiconductor storage device). All or a part of functions of the control device 23 may be realized using hardware such as an ASIC, a PLD, or an FPGA.

The control device 23 acquires information on an operation status of the second device 20 in which a host device is provided. The information on the operation status may be information on an operation status of an engine of the second device 20 provided with the control device 23 (for example, information indicating whether it is in an on state or in an off state). The information on the operation status may be, for example, information on an operation status of an electric motor of the second device 20 provided with the control device 23. As the information on the operation status, for example, information indicating whether a power supply of the second device 20 provided with the control device 23 is turned on or off may also be acquired.

The control device 23 generates basic operation information including identification information thereof stored in its own storage device, the positional information acquired by the positional information acquisition device 22, and information on an operation status every time a predetermined timing arrives. The control device 23 transmits the generated basic operation information to the management apparatus 40 via the mobile communication device 211.

The control device 23 receives identification information indicating the third device 30 and information on the operation status of the third device 30 from the third device 30 via the short-range communication device 212. The control device 23 generates basic operation information including the received information and positional information thereof. The control device 23 transmits the generated basic operation information to the management apparatus 40 via the mobile communication device 211.

The third device 30 is a device that is assigned one or a plurality of units to one unit group. The third device 30 differs from the second device 20 in that it does not have the mobile communication device and the positional information acquisition device. The third device 30 will be described in detail below.

The third device 30 is a device used by the members of a unit group, and is a device whose operation status in a predetermined area is managed. The third device 30 is, for example, a device used when predetermined work is performed. Such predetermined work may be any work. For example, the predetermined work may be lawn mowing work, may be a cleaning work, may be landscaping work, may be tree cutting work, may be manufacturing work, or may also be other work. When the predetermined work is lawn mowing work, specific examples of the third device 30 include a lawn mower operated by an engine and moved by a person walking, a lawn mower operated by an engine and moved by a person riding thereon and driving it, and the like. The third device 30 may be a device operated by an electric motor instead of an engine, or may be a device operated by electrically operating a device other than the motor. The third device 30 may be configured as, for example, a device without a battery.

The third device 30 includes the short-range communication device 31 and a control device 32. The short-range communication device 31 wirelessly communicates with other short-range communication devices positioned within a range of a predetermined short distance from a host device. The short-range communication device 31 may perform communication using, for example, a wireless LAN communication standard, may perform communication using a Bluetooth communication standard, or may perform communication using other communication standards. The short-range communication device 31 wirelessly communicates, for example, with the short-range communication device 112 of the first device 10 or the short-range communication device 212 of the second device 20.

The control device 32 includes a processor such as a CPU and a memory. The control device 32 operates when the processor executes a program (for example, a program stored in a storage device such as a magnetic storage device or a semiconductor storage device). All or a part of functions of the control device 32 may be realized using hardware such as an ASIC, a PLD, and an FPGA.

The control device 32 acquires information on the operation status of the third device 30 in which a host device is provided. The information on the operation status may be information on an operation status of an engine of the third device 30 provided with the control device 32 (for example, information indicating whether it is in an on state or in an off state). The information on the operation status may be, for example, information on an operation status of an electric motor of the third device 30 provided with the control device 32. As the information on the operation status, for example, information indicating whether a power supply of the third device 30 provided with the control device 32 is turned on or off may also be acquired.

The control device 32 transmits identification information thereof stored in its own storage device and the information on the operation status to the first device 10 or the second device 20 via the short-range communication device 31 every time a predetermined timing arrives.

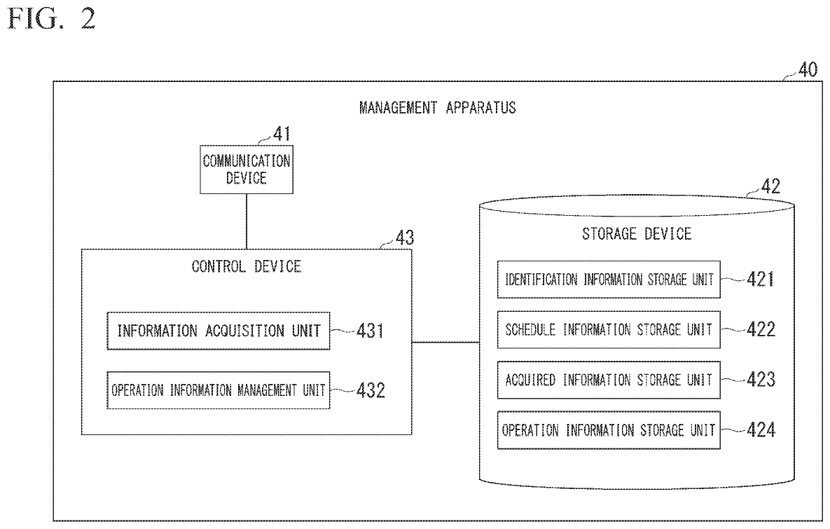

Next, the management apparatus 40 will be described. FIG. 2 is a diagram which shows a specific example of a functional configuration of the management apparatus 40. The management apparatus 40 is configured using an information processing apparatus such as a personal computer or a server device. The management apparatus 40 includes a communication device 41, a storage device 42, and a control device 43.

The communication device 41 is a communication device communicably connected to the network 90. The communication device 41 communicates with other devices via the network 90. For example, the communication device 41 communicates with the first device 10 and the second device 20.

The storage device 42 is configured using a storage device such as a magnetic hard disk device or a semiconductor storage device. The storage device 42 functions as an identification information storage unit 421, a schedule information storage unit 422, an acquired information storage unit 423, and an operation information storage unit 424.

The identification information storage unit 421 stores identification information of each device of the first device 10, the second device 20, and the third device 30, and the attribute information of each device in association with each other. The attribute information includes information indicating whether a corresponding device has a positional information acquisition unit, information indicating whether a corresponding device has a mobile communication device, and information indicating which one of the first to third devices a corresponding device is classified into, and the like.

The schedule information storage unit 422 stores, for each unit group, information indicating the first device 10 assigned to a corresponding unit group and information indicating work assigned to a corresponding unit group. The information indicating work may include, for example, information indicating an area where the work is performed (hereinafter referred to as a “work area”) (for example, geofence information) and information indicating a date and time when the work is performed.

The acquired information storage unit 423 stores information acquired by the control device 43. The acquired information storage unit 423 includes, for example, management information transmitted from the first device 10, the basic operation information transmitted from the second device 20, and the basic operation information transmitted from the third device 30 via the first device 10 or the second device 20.

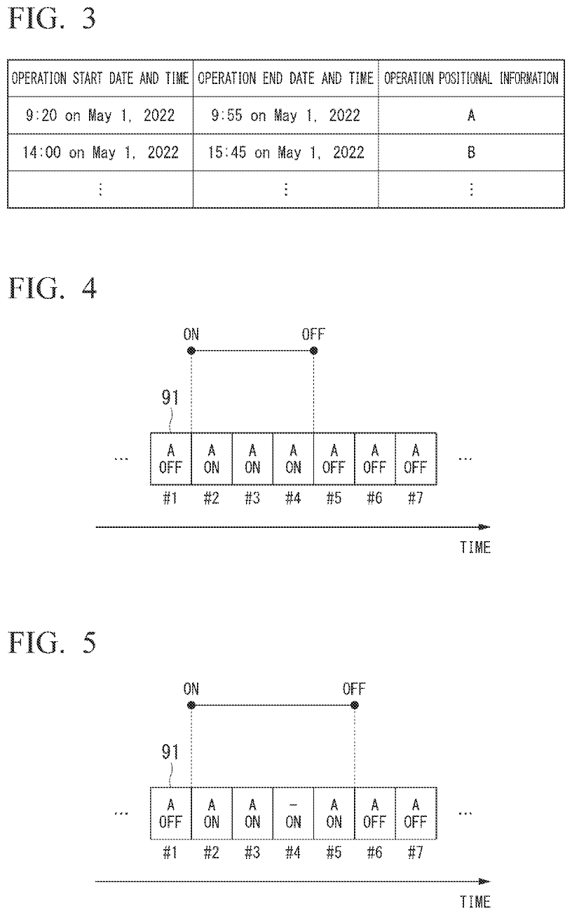

The operation information storage unit 424 stores operation information. Operation information is information generated on the basis of the basic operation information. FIG. 3 is a diagram which shows a specific example of the operation information. FIG. 3 shows an operation information table as the specific example of the operation information. The operation information storage unit 424 stores an operation information table for each second device 20. The operation information storage unit 424 may also store an operation information table for each third device 30.

The operation information table has each value of an operation start date and time, an operation end date and time, and operation positional information. An operation start date and time indicates a date and time when an operation of a corresponding device (the second device 20 or the third device 30) is started. In other words, the operation start date and time indicates a date and time when work using the device is started. An operation end date and time indicates a date and time when the operation of a corresponding device (the second device 20 or the third device 30) is ended. In other words, the operation end date and time indicates a date and time when work using the device is ended. Between the operation start date and time and the operation end date and time, it can be estimated that the operation of the device basically continues and work is continuously performed. Operation positional information indicates a position where work is performed from the operation start date and time to the operation end date and time of the same record.

For example, the operation information table shown in FIG. 3 shows that work has been continuously performed at a location A for 35 minutes from 9:20 on May 1, 2022 to 9:55 on the same day using a device (the second device 20 or the third device 30) corresponding to this operation information table. After that, the device (the second device 20 or the third device 30) corresponding to this operation information table has moved from A to B. Then, it shows that, using the device (the second device 20 or the third device 30) corresponding to this operation information table, work has been continuously performed at a location B for 1 hour and 45 minutes from 14:00 on the same day to 15:45 on the same day.

The operation start date and time indicates a timing at which an operation has first occurred after the basic operation information of the same device has indicated that there is no operation. The operation end date and time indicates a timing at which no operation has first occurred after the basic operation information of the same device has indicated that there is an operation. The operation positional information is determined on the basis of the positional information included in each basic operation information obtained from a timing at which the operation start date and time is obtained to a timing at which the operation end date and time is obtained. In the following description, a specific example of processing of determining the operation positional information will be described.

FIG. 4 is a diagram which shows a specific example of basic operation information continuously obtained from the same device in the management apparatus 40. One rectangle indicated by a reference numeral 91 indicates basic operation information. In FIG. 4, seven types of the basic operation information 91 are shown. FIG. 4 shows that time flows from left to right. For this reason, the basic operation information 91 shown on the leftmost side is the oldest basic operation information in FIG. 4, and the basic operation information 91 shown on the rightmost side is the newest basic operation information in FIG. 4. Numbers are attached to the basic operation information such as #1, #2, and so forth from the oldest. In each basic operation information 91, positional information is shown in the upper part, and information on an operation is shown in the lower part.

In FIG. 4, information “A” indicating a work area is shown as the positional information in the upper part for convenience of description, but the positional information of the basic operation information may contain values indicating coordinates (for example, latitude and longitude) instead of the work area itself in reality. In this case, the control device 43 of the management apparatus 40 determines a work area containing the coordinates on the basis of the information etc. contained in the schedule information storage unit 422. The information on an operation shown in the lower part may be represented by binary values such as “ON” and “OFF.”

In the case of FIG. 4, an operation has been in an “OFF” state in basic operation information of #1, but the operation is turned “ON” in basic operation information of #2 obtained at the next timing. For this reason, a timing at which the basic operation information of #2 is obtained is set to the operation start date and time. After that, the operation continues to be in the “ON” state until basic operation information of #4 is obtained. Then, the operation is turned “OFF” in basic operation information of #5. For this reason, a timing at which the basic operation information of #5 is obtained is set to the operation end date and time.

The operation positional information is determined on the basis of work areas indicated by positional information in the basic operation information obtained from the operation start date to time and the operation end date and time. For example, a most common work area indicated by the positional information in the basic operation information obtained from the operation start date and time to the operation end date and time may be determined as the operation positional information. In the case of FIG. 4, work areas in the basic operation information obtained from the operation start date and time to the operation end date and time are all “A,” so that the operation positional information is determined as “A.”

FIG. 5 is a diagram which shows a specific example of the basic operation information continuously obtained from the same device in the management apparatus 40. In the case of FIG. 5, an operation has been in an “OFF” state in the basic operation information of #1, but the operation is turned “ON” in the basic operation information of #2 obtained at the next timing. For this reason, a timing at which the basic operation information of #2 is obtained is set to the operation start date and time. After that, the operation continues to be in the “ON” state until the basic operation information of #5 is obtained. Then, the operation is turned “OFF” in basic operation information of #6. For this reason, a timing at which the basic operation information of #6 is obtained is set to the operation end date and time.

The operation positional information is determined on the basis of work areas indicated by positional information in the basic operation information obtained from the operation start date and time to the operation end date and time. For example, a most common work area indicated by the positional information for which values are obtained in the basic operation information obtained from the operation start date and time to the operation end date and time may be determined as the operation positional information. In the case of FIG. 5, there is basic operation information (#4) that does not include positional information as part of basic operation information from the operation start date and time to the operation end date and time. For this reason, there are three pieces of positional information for which values are obtained. A most common work area among these three pieces may be determined as the operation positional information. In the case of FIG. 5, all the work areas in the positional information for which values are obtained are “A,” so that the operation positional information is determined as “A.”

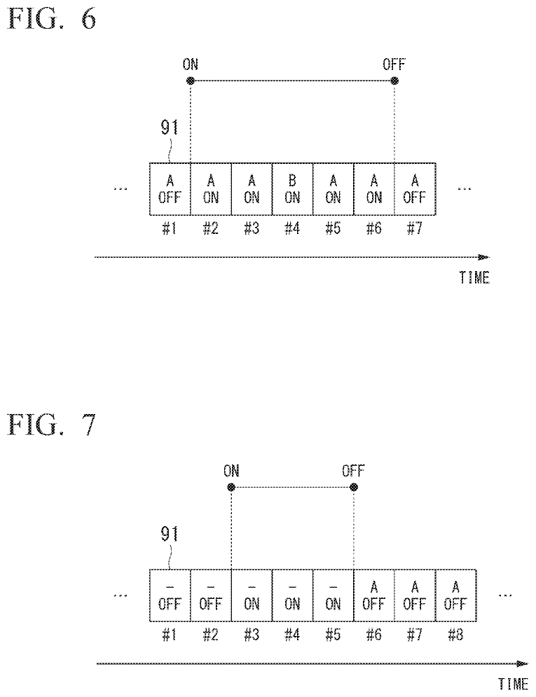

FIG. 6 is a diagram which shows a specific example of the basic operation information continuously obtained from the same device in the management apparatus 40. In the case of FIG. 6, an operation has been in an “OFF” state in the basic operation information of #1, but the operation is turned “ON” in the basic operation information of #2 obtained at the next timing. For this reason, a timing at which the basic operation information of #2 is obtained becomes the operation start date and time. After that, the operation continues to be in the “ON” state until basic operation information of #6 is obtained. Then, the operation is turned “OFF” in basic operation information of #7. For this reason, a timing at which the basic operation information of #7 is obtained is set to the operation end date and time.

The operation positional information is determined on the basis of work areas indicated by positional information in the basic operation information obtained from the operation start date and time to the operation end date and time. For example, a most common work area indicated by the positional information in the basic operation information obtained from the operation start date and time to the operation end date and time may be determined as the operation positional information. In the case of FIG. 6, there are five pieces of positional information for which values are obtained from the operation start date and time to the operation end date and time. A most common work area among these five pieces may be determined as the operation positional information. In the case of FIG. 6, four of work areas in the positional information for which values are obtained are “A” and one is “B.” For this reason, the operation positional information is determined as “A.”

FIG. 7 is a diagram which shows a specific example of the basic operation information continuously obtained from the same device in the management apparatus 40. In the case of FIG. 7, an operation has been in the “OFF” in the basic operation information of #2, but the operation is turned “ON” in the basic operation information of #3 obtained at the next timing. For this reason, a timing at which the basic operation information of #3 is obtained is set to the operation start date and time. After that, the operation continues to be in the “ON” state until the basic operation information of #5 is obtained. Then, the operation is turned “OFF” in basic operation information of #6. For this reason, a timing at which the basic operation information of #6 is obtained is set to the operation end date and time.

The operation positional information is determined on the basis of work areas indicated by positional information in the basic operation information obtained from the operation start date and time to the operation end date and time. For example, when no values for positional information are obtained from the operation start date and time to the operation end date and time, among pieces of basic operation information of other periods in which values of positional information are obtained, a work area indicated by positional information of basic operation information, positioned at a timing closest to the operation start date and time or the operation end date and time may be determined as the operation positional information. In the case of FIG. 7, no positional information is obtained from the operation start date and time to the operation end date and time. Then, among pieces of the basic operation information of other periods in which values of positional information are obtained, the basic operation information positioned at the timing closest to the operation start date and time or the operation end date and time is the basic operation information of #6. For this reason, a work area indicated by positional information of the basic operation information of #6 may be determined as the operation positional information. In this case, the operation positional information is determined as “A.”

FIG. 8 is a diagram which shows a specific example of the basic operation information continuously obtained from the same device in the management apparatus 40. In the case of FIG. 8, an operation has been in the “OFF” in the basic operation information of #2, but the operation is turned “ON” in the basic operation information of #3 obtained at the next timing. For this reason, a timing at which the basic operation information of #3 is obtained is set to the operation start date and time. After that, the operation continues to be in the “ON” state until the basic operation information of #5 is obtained. Then, the operation is turned “OFF” in basic operation information of #6. For this reason, a timing at which the basic operation information of #6 is obtained is set to the operation end date and time.

The operation positional information is determined on the basis of work areas indicated by positional information in the basic operation information obtained from the operation start date and time to the operation end date and time. For example, when no values for positional information are obtained from the operation start date and time to the operation end date and time, among pieces of basic operation information in which positional information is obtained after the operation end date and time, a work area indicated by positional information of basic operation information, positioned at a timing closest to the operation end date and time may be determined as the operation positional information. In the case of FIG. 8, no positional information is obtained from the operation start date and time to the operation end date and time. Then, among pieces of the basic operation information of other periods in which values of positional information are obtained after the operation end date and time, the basic operation information positioned at the timing closest to the operation end date and time is basic operation information of #8. For this reason, a work area indicated by positional information of the basic operation information of #8 may be determined as the operation positional information. In this case, the operation positional information is determined as “A.”

A specific example of other determination processing will be described by using FIG. 8. When no values for positional information are obtained from the operation start date and time to the operation end date and time, among pieces of the basic operation information of other periods in which values of positional information are obtained, a work area indicated by positional information of basic operation information, positioned at a timing closest to the operation start date and time or the operation end date and time may be determined as the operation positional information. In the case of FIG. 8, no positional information is obtained from the operation start date and time to the operation end date and time. Then, among pieces of the basic operation information of other periods in which values of positional information are obtained, the basic operation information positioned at the timing closest to the operation start date and time or the operation end date and time is the basic operation information of #2. For this reason, the work area indicated by the positional information of the basic operation information of #2 may be determined as the operation positional information. In this case, the operation positional information is determined as “A.”

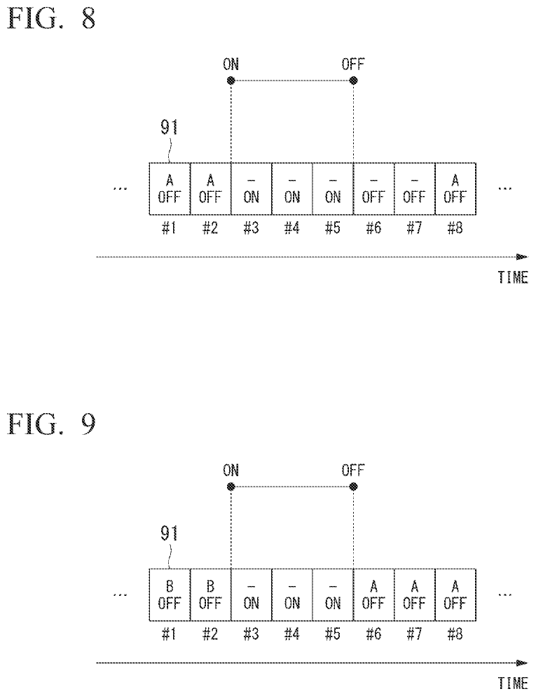

FIG. 9 is a diagram which shows a specific example of the basic operation information continuously obtained from the same device in the management apparatus 40. In the case of FIG. 9, an operation has been in the “OFF” in the basic operation information of #2, but the operation is turned “ON” in the basic operation information of #3 obtained at the next timing. For this reason, a timing at which the basic operation information of #3 is obtained is set to the operation start date and time. After that, the operation continues to be in the “ON” state until the basic operation information of #5 is obtained. Then, the operation is turned “OFF” in basic operation information of #6. For this reason, a timing at which the basic operation information of #6 is obtained is set to the operation end date and time.

The operation positional information is determined on the basis of work areas indicated by positional information in the basic operation information obtained from the operation start date and time to the operation end date and time. For example, when no values for positional information are obtained from the operation start date and time to the operation end date and time, among pieces of the basic operation information of other periods in which values of positional information are obtained, a work area indicated by positional information of basic operation information, positioned at a timing closest to the operation start date and time or the operation end date and time may be determined as the operation positional information. Furthermore, when there are a plurality of pieces of basic operation information positioned at the timing closest to the operation start date and time or operation end date and time, a work area indicated by positional information of the basic operation information positioned at the timing closest to the operation end date and time may be determined as the operation positional information. In the case of FIG. 9, no positional information is obtained from the operation start date and time to the operation end date and time. Among pieces of the basic operation information of other periods in which values of positional information are obtained, the basic operation information positioned at the timing closest to the operation start date and time or the operation end date and time is the basic operation information of #2 and #6. Then, the basic operation information positioned at the timing closest to the operation end date and time is the basic operation information of #6. For this reason, the work area indicated by the positional information of the basic operation information of #6 may be determined as the operation positional information. In this case, the operation positional information is determined as “A.”

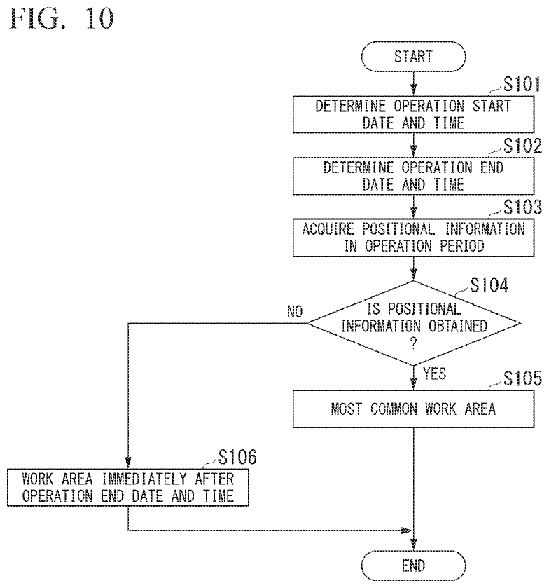

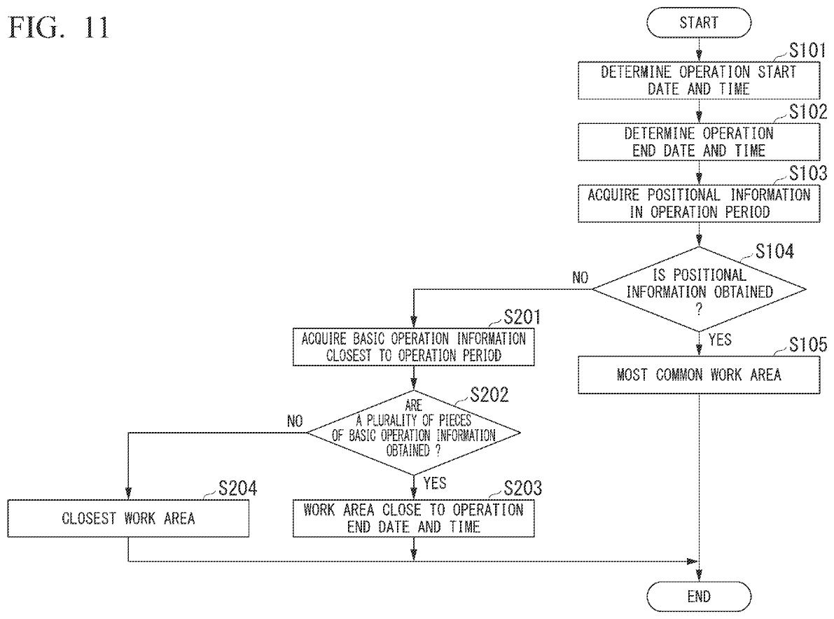

FIG. 10 is a flowchart which shows a specific example of processing of an operation information management unit 432 provided in the management apparatus 40. First, the operation information management unit 432 determines an operation start date and time and an operation end date and time (step S101, step S102). The operation information management unit 432 acquires positional information in basic operation information of an operation period between the operation start date and time and the operation end date and time (step S103). When at least a predetermined number (for example, one) of pieces of positional information is obtained in basic operation information of an operation period (YES in step S104), a most common work area among pieces of the obtained positional information is set as operation positional information (step S105).

When at least a predetermined number (for example, one) of pieces of positional information is not obtained in the basic operation information of the operation period (NO in step S104), a work area immediately after the operation end date and time is determined as the operation positional information (step S106). In other words, among pieces of the basic operation information in which positional information is obtained after the operation end date and time, a work area of the basic operation information at the timing closest to the operation end date and time is determined as the operation positional information.

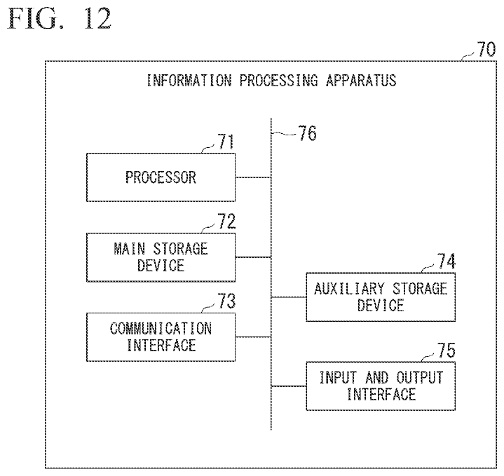

FIG. 11 is a flowchart which shows another specific example of the processing of the operation information management unit 432 provided in the management apparatus 40. Steps S101 to S105 are the same as in FIG. 10, so that description thereof will be omitted. When at least a predetermined number (for example, one) of pieces of positional information is not obtained in the basic operation information of the operation period (NO in step S104), among pieces of basic operation information outside the operation period, basic operation information at a timing closest to the operation period is acquired (step S201). When a plurality of pieces of such basic operation information are obtained (YES in step S202), a work area of positional information close to the operation end date and time is determined as the operation positional information (step S203). On the other hand, when one piece of such basic operation information is obtained (NO in step S202), a work area of the basic operation information (a closest work area) is determined as the operation positional information (step S204).

FIG. 12 is a diagram which shows an outline of a hardware configuration example of an information processing apparatus 70 applied to the present embodiment. The information processing apparatus 70 has a processor 71, a main storage device 72, a communication interface 73, an auxiliary storage device 74, an input and output interface 75, and an internal bus 76. The processor 71, the main storage device 72, the communication interface 73, the auxiliary storage device 74, and the input and output interface 75 are communicably connected to each other via the internal bus 76. The information processing apparatus 70 may be applied to, for example, the management apparatus 40. In this case, for example, the communication device 41 may be configured using the communication interface 73. For example, the storage device 42 may be configured using the auxiliary storage device 74. In addition, the control device 43 may also be configured using the processor 71 and the main storage device 72.

According to the management system 100 configured in this manner, it is possible to curb a deterioration in accuracy of the position of a device to be managed. Specifically, it is as follows. In the management system 100, regarding an area (for example, a work area) indicated by a plurality of pieces of positional information of a device to be managed, obtained in a period to be managed (an operation period), a most common area indicated in these pieces of information is determined as final positional information (for example, the operation positional information). For this reason, even if a plurality of types of positional information indicating different areas are acquired in the period to be managed due to problems such as accuracy of positional information acquisition and the like, or even if there is a period in which positional information cannot be acquired, it is possible to determine a most valid area from the obtained positional information as the final positional information. Therefore, it is possible to curb a deterioration in accuracy of the position of a device.

In addition, in the management system 100, even if a predetermined number or more (for example, one or more) of pieces of positional information of a device to be managed cannot be obtained in the period to be managed (the operation period), final positional information (for example, the operation positional information) is determined on the basis of positional information obtained in other periods. For this reason, even if a predetermined number or more of pieces of positional information of a device to be managed cannot be obtained in the period to be managed (the operation period), a valid area can be determined as the final positional information. Therefore, it is possible to curb a deterioration in accuracy of the position of a device.

### Modified Example

In the description above, at least the second device 20 is used as a device to be managed. In the management system 100, in addition to the second device 20, the third device 30 may also be used as a device to be managed. Moreover, in the management system 100, in addition to the second device 20, the first device 10 may also be used as a device to be managed.

In the description above, an operation period is used as a specific example of a period to be managed, but the period to be managed does not have to be limited to the operation period. For example, in particular, a regardless of whether in operation, a position that has been present in a predetermined period may be determined, a position that has been present in a period of inactivity may be determined, and a position in other periods may also be determined.

The management apparatus 40 may be configured using one information processing apparatus, or may be configured using a plurality of information processing apparatuses. For example, the storage device 42 and the control device 43 may be mounted on different information processing apparatuses. For example, the information acquisition unit 431 and the operation information management unit 432 of the control device 43 may be mounted on different information processing apparatuses. For example, information stored in the storage device 42 may be distributed and stored in a plurality of storage devices.

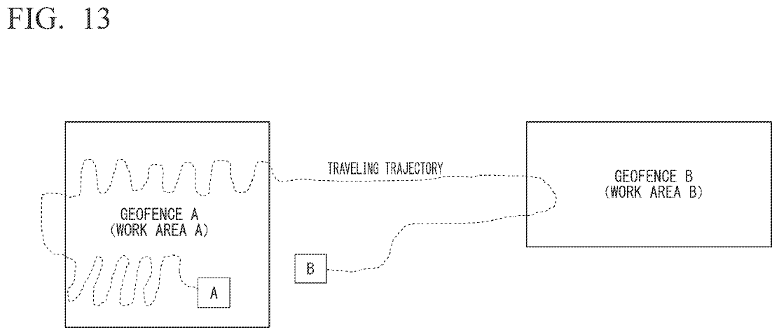

FIG. 13 is a diagram for describing an example of a traveling trajectory of the first equipment (hereinafter, the first device 10 and the second device 20 are referred to as a “first equipment”) according to the embodiment. An example of a traveling trajectory of the first equipment will be described with reference to FIG. 13. FIG. 13 shows geographical ranges of two sites specified as geofence A (work area A) and geofence B (work area B). A point A is present within a range of the geofence A, and a point B is present outside the ranges of the geofence A and geofence B. In addition, a dashed line in FIG. 13 indicates the traveling trajectory when the first equipment moves from the point A to the point B. Specifically, the first equipment may be the ZTR (Zero-Turn Mower; riding lawn mower).

When the first equipment is moving within the range of the geofence A (that is, the dashed line is within the range of the geofence A), it can be determined that the first equipment is within the range of the geofence A based on the positional information corresponding to the first equipment and the work area information stored in the schedule information storage unit 422. Here, the first equipment once leaves the range of the geofence A, and then returns to the range of the geofence A again. In such a case, it is conceivable that it is determined that the first equipment is out of the range of the geofence A, and erroneously determined that work has ended based on the positional information corresponding to the first equipment and the area information stored in the schedule information storage unit 422. However, even in such a case, the management apparatus 40 does not immediately determine that work has ended, but regards a period of being outside the range of the geofence A as being present within the range of the geofence A, and determines that work continues. Whether work continues may be determined depending on, for example, the period of being outside the range of a site (how long it is separated from the site), the positional information (how far it is separated from the site), and the like.

In addition, in the shown example, the first equipment once leaves the range of the geofence A, enters the range of the geofence B, which is an adjacent site, and leaves the range of the geofence B again. In such a case, it is conceivable that it is determined that the first equipment is present within the geofence B, and erroneously determined that work in the geofence A has ended and work in the geofence B has started, based on the positional information corresponding to the first equipment and the work area information stored in the schedule information storage unit 422. Even in such a case, the management apparatus 40 does not immediately determine that the work in the geofence A has ended and the work in the geofence B has started, regards a period of being outside the range of the geofence A as being within the geofence A, and determines that work continues. Whether work continues may also be determined depending on, for example, the period of being outside the range of a site, the positional information, and the like.

Although the embodiment of the present invention has been described in detail with reference to the drawings, the specific configuration is not limited to the present embodiment, and includes design within a range not departing from the gist of the present invention.

What is claimed is:

1. A management apparatus comprising:
a control device configured to acquire a plurality of pieces of positional information of a device to be managed over a predetermined period, and determine an area in which each positional information corresponding to predetermined area are obtained the most in the predetermined period as an area in which the device to be managed has been present in the predetermined period.

2. The management apparatus according to claim 1,
wherein the control device determines an area in which the device to be managed has been present on the basis of positional information obtained outside the predetermined period when a predetermined number or more of pieces of positional information are not obtained in the predetermined period.

3. The management apparatus according to claim 2,
wherein the control device determines an area in which the device to be managed has been present on the basis of positional information obtained at a timing after an end of the predetermined period and closest to the end of the predetermined period.

4. The management apparatus according to claim 2,
wherein the control device determines an area in which the device to be managed has been present on the basis of positional information obtained at a timing closest to the predetermined period.

5. A management method comprising:
acquiring a plurality of pieces of positional information of a device to be managed over a predetermined period; and
determining an area in which each positional information corresponding to predetermined area are obtained the most, in the predetermined period as an area in which the device to be managed has been present in the predetermined period.

6. A management method comprising:
acquiring a plurality of pieces of positional information of a device to be managed over a predetermined period; and
determining an area in which the device to be managed has been present on the basis of positional information obtained outside the predetermined period when each piece of the positional information corresponding to predetermined areas is not obtained in the predetermined period.

7. The management method according to claim 6,
wherein determining an area in which the device to be managed has been present on the basis of positional information obtained at a timing after an end of the predetermined period and closest to the end of the predetermined period.

8. The management method according to claim 6,
wherein determining an area in which the device to be managed has been present on the basis of positional information obtained at a timing closest to the predetermined period.
